(19) United States
(12) Patent Application Publication
(10) Pub. No.: US 2018/0176445 A1
(43) Pub. Date: Jun. 21, 2018

(54) IMAGING DEVICE AND IMAGING METHOD

(71) Applicant: SONY SEMICONDUCTOR SOLUTIONS CORPORATION, Atsugi-shi, Kanagawa (JP)

(72) Inventor: Takahiro IINUMA, Kanagawa (JP)

(21) Appl. No.: 15/737,083

(22) PCT Filed: Jun. 9, 2016
(86) PCT No.: PCT/JP2016/067194

§ 371 Date: Dec. 15, 2017

(30) Foreign Application Priority Data
Jun. 23, 2015 (JP) 2015-125360

(51) Int. Cl. H04N 5/235; G03B 7/091; H04N 5/238; H04N 9/73; H04N 5/232

(52) U.S. Cl. CPC H04N 5/2355; G03B 7/091; H04N 5/238; H04N 5/23212; H04N 5/2351; H04N 5/2353; H04N 9/735

(57) ABSTRACT

The present disclosure relates to an imaging device and an imaging method that enable more appropriate exposure control to be performed quickly. An image sensor includes an image sensor in which an exposure detection pixel configured to output a pixel value to be used for detection of brightness of a subject and an effective pixel configured to output a pixel value effective for construction of an image are arranged in an imaging effective area to be utilized for imaging of the image; and an exposure control unit configured to control exposure time of the image sensor on the basis of the pixel value output from the exposure detection pixel. Furthermore, the pixel value of the exposure detection pixel has a higher dynamic range than the pixel value of the effective pixel. The present technology can be applied to an image sensor including AE control, for example.

### TECHNICAL FIELD

The present disclosure relates to an imaging device and an imaging method, and more particularly to an imaging device and an imaging method that enable more appropriate exposure control to be performed quickly.

### BACKGROUND ART

Generally, an imaging device including an image sensor, such as a charge coupled device (CCD) or a complementary metal oxide semiconductor (CMOS) image sensor, images a subject by collecting light from the subject with an optical system and forming an image on a sensor surface of the image sensor. Moreover, in the imaging device, when imaging a subject, various types of control, such as automatic exposure (AE) control of automatically adjusting exposure such that the subject has optimum brightness, auto-focus (AF) control of automatically adjusting the focus such that the subject is brought into focus, and auto white balance (AWB) control of automatically performing a correction such that the color tone of the subject is reproduced accurately, is performed.

For example, in the AE control in a conventional imaging device, arranged separately from an image sensor is a sensor for exposure control, and on the basis of a signal output from that sensor, appropriate exposure time is obtained. Alternatively, by measuring an exposure state on the basis of an image captured with the image sensor, appropriate exposure time is obtained.

In addition, Patent Literature 1 discloses a solid state image sensor that achieves phase difference AF on the basis of a signal from pixels for phase difference detection provided within the solid state image sensor, and utilizes the pixels for phase difference detection in actual shooting as well. In addition, Patent Literature 2 discloses a solid state image sensor in which pixels capable of operating in a low sensitivity mode and a high sensitivity mode are applied to a line sensor for phase difference AF.

### CITATION LIST

### Patent Literature

Patent Literature 1: JP 2011-59337A

Patent Literature 2: JP 2014-222928A

### DISCLOSURE OF INVENTION

### Technical Problem

Meanwhile, as described above, in the configuration where the sensor for exposure control is provided separately from the image sensor, a mismatch occurs in control when imaging a subject in a case where there is a difference in properties between the image sensor and the sensor for control, so that appropriate AE control cannot be performed. In addition, in the configuration that measures an exposure state on the basis of an image captured with the image sensor, several frames may be required until control is exerted so as to achieve appropriate exposure for a high-contrast subject, for example.

The present disclosure was made in view of such circumstances, and enables more appropriate exposure control to be performed quickly.

### Solution to Problem

An imaging device according to an aspect of the present disclosure includes: an image sensor in which an exposure detection pixel configured to output a pixel value to be used for detection of brightness of a subject and an effective pixel configured to output a pixel value effective for construction of an image are arranged in an imaging effective area to be utilized for imaging of the image; and an exposure control unit configured to control exposure of the image sensor on the basis of the pixel value output from the exposure detection pixel. The pixel value of the exposure detection pixel has a higher dynamic range than the pixel value of the effective pixel.

An imaging method according to an aspect of the present disclosure is an imaging method of an imaging device including an image sensor in which an exposure detection pixel configured to output a pixel value to be used for detection of brightness of a subject and an effective pixel configured to output a pixel value effective for construction of an image are arranged in an imaging effective area to be utilized for imaging of the image, and the pixel value of the exposure detection pixel has a higher dynamic range than the pixel value of the effective pixel, the imaging method including: a step of controlling exposure of the image sensor on the basis of the pixel value output from the exposure detection pixel.

According to an aspect of the present disclosure, an imaging device includes an image sensor in which an exposure detection pixel configured to output a pixel value to be used for detection of brightness of a subject and an effective pixel configured to output a pixel value effective for construction of an image are arranged in an imaging effective area to be utilized for imaging of the image. The pixel value of the exposure detection pixel has a higher dynamic range than the pixel value of the effective pixel. Exposure of the image sensor is controlled on the basis of the pixel value output from the exposure detection pixel.

### Advantageous Effects of Invention

According to an aspect of the present disclosure, it is possible to perform more appropriate exposure control quickly.

### BRIEF DESCRIPTION OF DRAWINGS

FIG. 1 is a block diagram showing a configuration example of a first embodiment of an imaging device.

FIG. 2 is an illustration describing a first arrangement example of OPD pixels.

FIG. 3 is an illustration describing a second arrangement example of OPD pixels.

FIG. 4 is a flowchart describing a process of imaging a still image.

FIG. 5 is a flowchart describing a process of imaging a moving image.

FIG. 6 is a block diagram showing a configuration example of a second embodiment of an imaging device.

FIG. 7 is a block diagram showing a configuration example of a third embodiment of an imaging device.

FIG. 8 is a block diagram showing a configuration example of a fourth embodiment of an imaging device.

FIG. 9 is an illustration showing a usage example of using an image sensor.

### MODE(S) FOR CARRYING OUT THE INVENTION

Hereinafter, specific embodiments to which the present technology has been applied will be described in detail with reference to the drawings.

### First Embodiment of Imaging Device

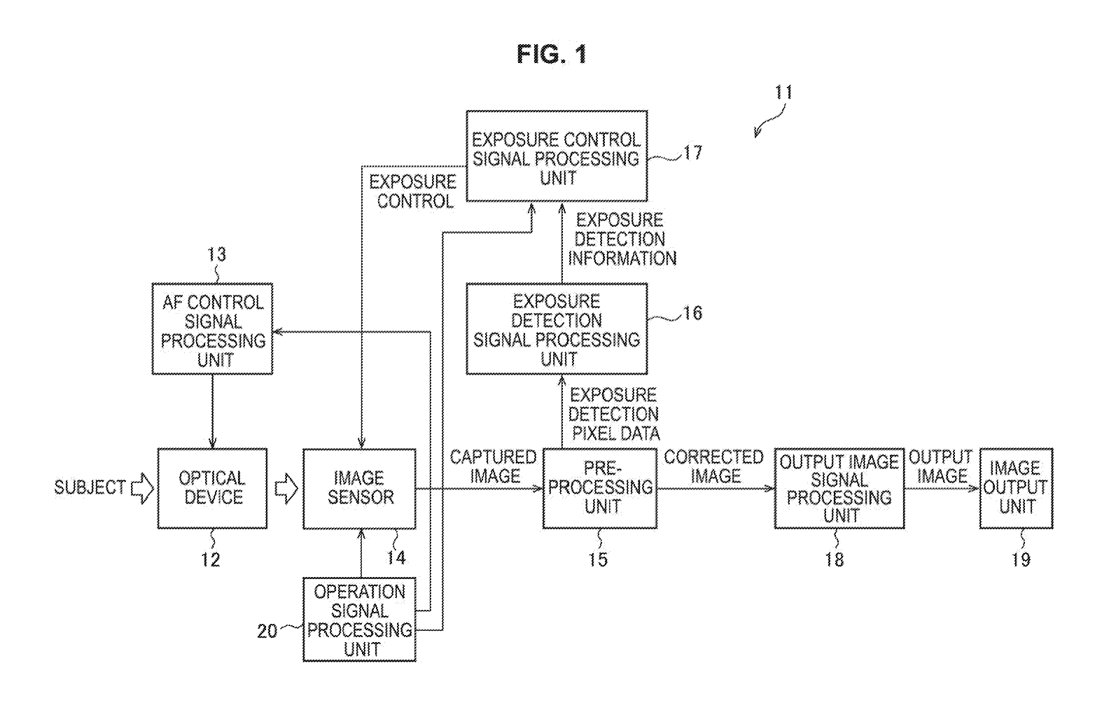

FIG. 1 is a block diagram showing a configuration example of a first embodiment of an imaging device to which the present technology has been applied.

In FIG. 1, an imaging device 11 includes an optical device 12, an AF control signal processing unit 13, an image sensor 14, a preprocessing unit 15, an exposure detection signal processing unit 16, an exposure control signal processing unit 17, an output image signal processing unit 18, an image output unit 19, and an operation signal processing unit 20.

The optical device 12 has a plurality of optical lenses, an AF driving unit, and the like, and forms an image of a subject on a sensor surface of the image sensor 14 by collecting light from the subject with the optical lenses and driving the optical lenses in accordance with control exerted by the AF control signal processing unit 13.

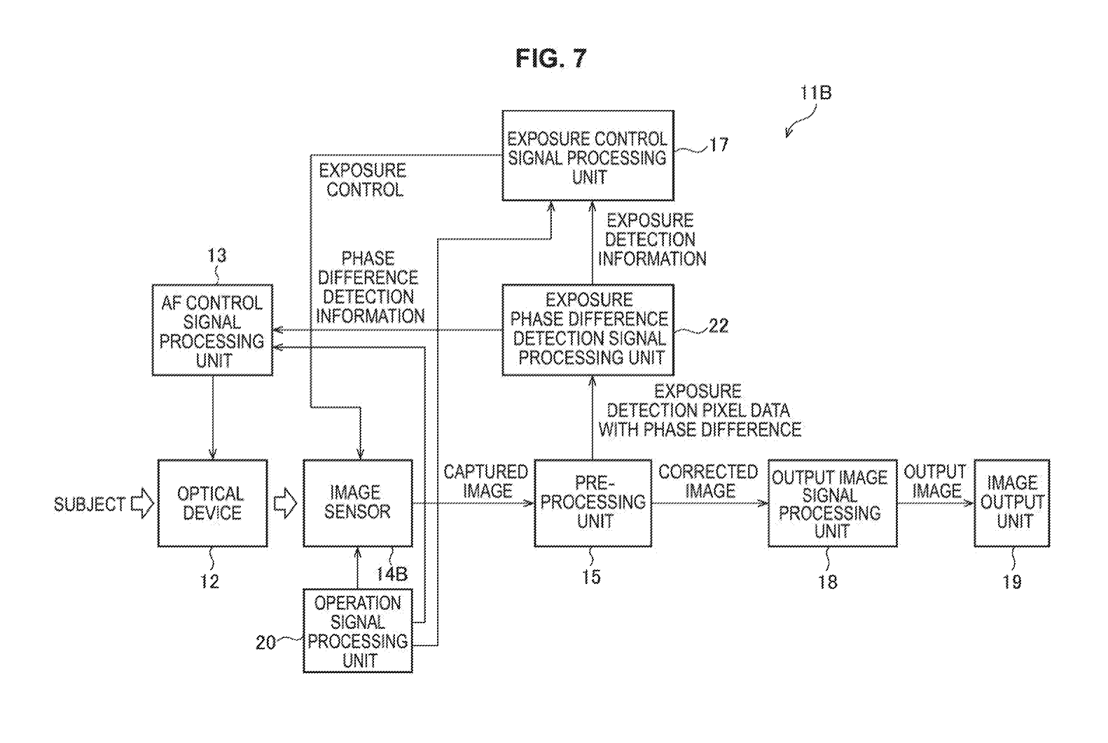

The AF control signal processing unit 13 controls the AF driving unit of the optical device 12 such that a subject is brought into focus on the basis of an output of a line sensor not shown, a contrast of a captured image, and the like, or on the basis of phase difference detection information from an exposure phase difference detection signal processing device 22 of FIG. 7 which will be described later, for example.

The image sensor 14 has a sensor surface in which a plurality of pixels are arranged in a matrix form, and supplies, to the preprocessing unit 15, a captured image constructed by pixel values in accordance with the amount of received light of pixels arranged in an imaging effective area to be utilized for imaging of an image. In addition, pixels specialized in detection of brightness of an imaging environment (hereinafter referred to as optical photo detector (OPD) pixels) are arranged in the sensor surface of the image sensor 14, besides pixels to be used for normal imaging.

In addition, a configuration in which a wide dynamic range can be taken is adopted for the OPD pixels of the image sensor 14. For example, a logarithmic pixel that outputs a pixel signal which is logarithmic with respect to the amount of light and does not saturate even if strong light is received can be used as an OPD pixel. In addition, similarly to imaging of a high dynamic range (HDR) image, a plurality of pixels having different sensitivity or exposure time can be used as one OPD pixel. Note that, among pixels arranged in the sensor surface of the image sensor 14, pixels other than the OPD pixels will hereinafter be referred to as effective pixels as necessary, and it is assumed that pixel values of the OPD pixels have a higher dynamic range (can distinguish a wider range of amount of light) than the effective pixels to be effectively used for construction of an image.

The preprocessing unit 15 extracts pixel values obtained through the OPD pixels from a captured image supplied from the image sensor 14, and supplies the pixel values to the exposure detection signal processing unit 16 as exposure detection pixel data. In addition, the preprocessing unit 15 performs correction processing of obtaining, by interpolation, pixel values at locations corresponding to the positions at which the OPD pixels are arranged, using the pixel values obtained through the effective pixels in a captured image supplied from the image sensor 14.

Here, in the image sensor 14, for example, a red, green, and blue color filter is arranged on the effective pixels in accordance with a Bayer layout, and the OPD pixels are made colorless in order to detect brightness. Therefore, in accordance with the Bayer layout, the preprocessing unit 15 obtains pixel values at locations corresponding to the positions at which the OPD pixels are arranged by linearly interpolating pixel values of a plurality of effective pixels having the same color as the color originally arranged at the positions at which the OPD pixels are arranged and being present in proximity to the OPD pixels. Then, the preprocessing unit 15 supplies a corrected image obtained by carrying out correction processing on a captured image to the output image signal processing unit 18.

The exposure detection signal processing unit 16 performs detection by integrating the exposure detection pixel data supplied from the preprocessing unit 15 in a spatial direction, for example, to acquire exposure detection information obtained by detecting an exposure state of a subject, and supplies the exposure detection information to the exposure control signal processing unit 17.

The exposure control signal processing unit 17 obtains such exposure time of the image sensor 14 in which the subject is captured at appropriate brightness on the basis of the exposure detection information supplied from the exposure detection signal processing unit 16, and performs exposure control over the image sensor 14.

The output image signal processing unit 18 carries out various types of image processing, such as a white balance adjustment and a gamma correction, for example, on the corrected image supplied from the preprocessing unit 15. Then, the output image signal processing unit 18 supplies an output image obtained by carrying out image processing on the corrected image to the image output unit 19.

The image output unit 19 has a display device, such as a liquid crystal panel or an organic electro luminescence (EL) panel, for example, and displays the output image supplied from the output image signal processing unit 18. In addition, the image output unit 19 is configured with a built-in type or removable recording medium, and records the output image supplied from the output image signal processing unit 18.

The operation signal processing unit 20, to which an operation signal in accordance with an operation performed by a user on an operation unit not shown, performs processing based on the operation signal. For example, in accordance with an operation of setting an imaging mode of the imaging device 11 at a still image or a moving image, the operation signal processing unit 20 performs control over the image sensor 14 so as to capture a still image or a moving image. In addition, for example, when a shutter operation is performed when the imaging mode of the imaging device 11 is set at a still image, the operation signal processing unit 20 performs control over the image sensor 14 so as to output a still image at the time when the operation is performed. In addition, in accordance with a user operation, the operation signal processing unit 20 performs various settings for processing to be performed in the AF control signal processing unit 13 and the exposure control signal processing unit 17.

The imaging device 11 configured in this manner can always observe an exposure state of a subject with the OPD pixels, and can perform always appropriate exposure control.

In addition, in a configuration that measures an exposure state from a captured image to perform AE control in a conventional imaging device, for example, loss of information due to blown-out highlights (overexposure) and blocked-up shadows (underexposure) or the like occurs particularly for a high-contrast subject, which requires time to converge AE control.

In contrast, the imaging device 11 can perform AE control on the basis of pixel values of the OPD pixels having a wide dynamic range, and thus, an adjustment to an optimum exposure state can be made quickly (in one frame) without saturation of the pixel values even if a subject has a high contrast. That is, the imaging device 11 can exert control such that proper exposure is achieved at a high speed from any exposure state.

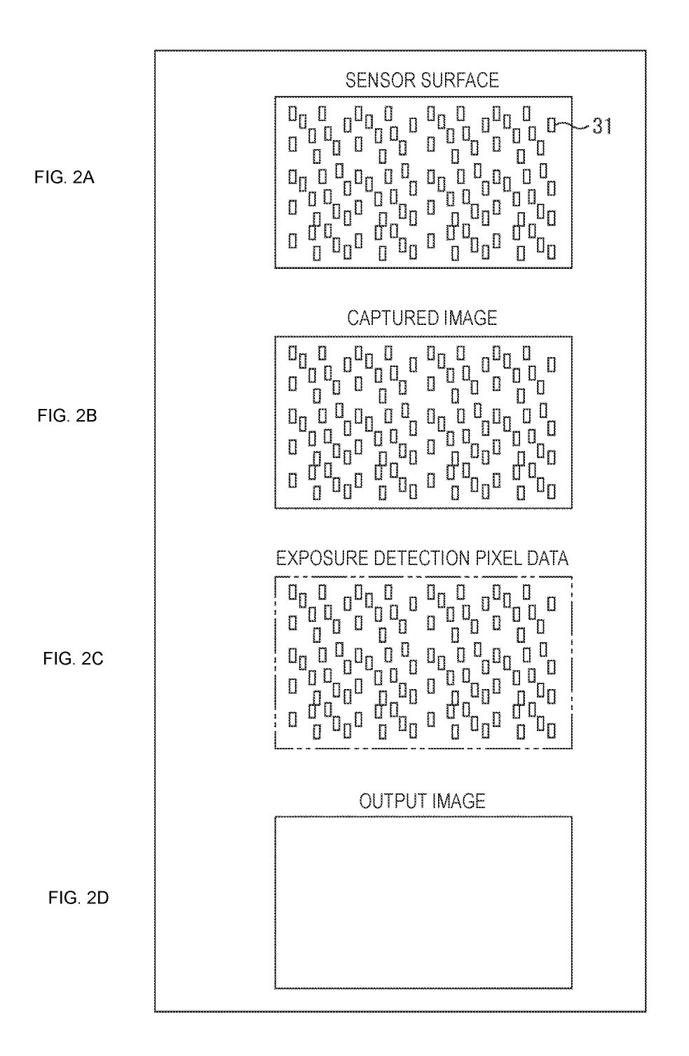

Next, a first arrangement example of OPD pixels arranged in the sensor surface of the image sensor 14 will be described with reference to FIG. 2.

FIG. 2 shows at A the sensor surface of the image sensor 14, and as shown in the drawing, the OPD pixels 31 can be arranged at random in the sensor surface.

A captured image captured with the image sensor 14 having a configuration in which the OPD pixels 31 are arranged at random in this manner will have pixel values of the OPD pixels arranged at random in accordance with the positions at which the OPD pixels 31 are arranged, as shown in FIG. 2 at B. Then, by extracting the pixel values of the OPD pixels from such a captured image, the preprocessing unit 15 acquires exposure detection pixel data as shown in FIG. 2 at C. Detection is performed by the exposure detection signal processing unit 16 using such exposure detection pixel data, and exposure control is performed by the exposure control signal processing unit 17.

On the other hand, the preprocessing unit 15 performs correction processing of interpolating pixel values at locations corresponding to the positions at which the OPD pixels are arranged, using remaining pixel values after extracting the exposure detection pixel data from the captured image, that is, using pixel values of effective pixels. Accordingly, the preprocessing unit 15 outputs a corrected image composed of pixel values at all the pixel positions of the image sensor 14, which is subjected to image processing by the output image signal processing unit 18, and an output image as shown in FIG. 2 at D is output.

In this manner, the image sensor 14 in which the OPD pixels 31 are arranged at random can also perform exposure control accurately for a subject having a periodic pattern, for example, without being influenced by its periodicity.

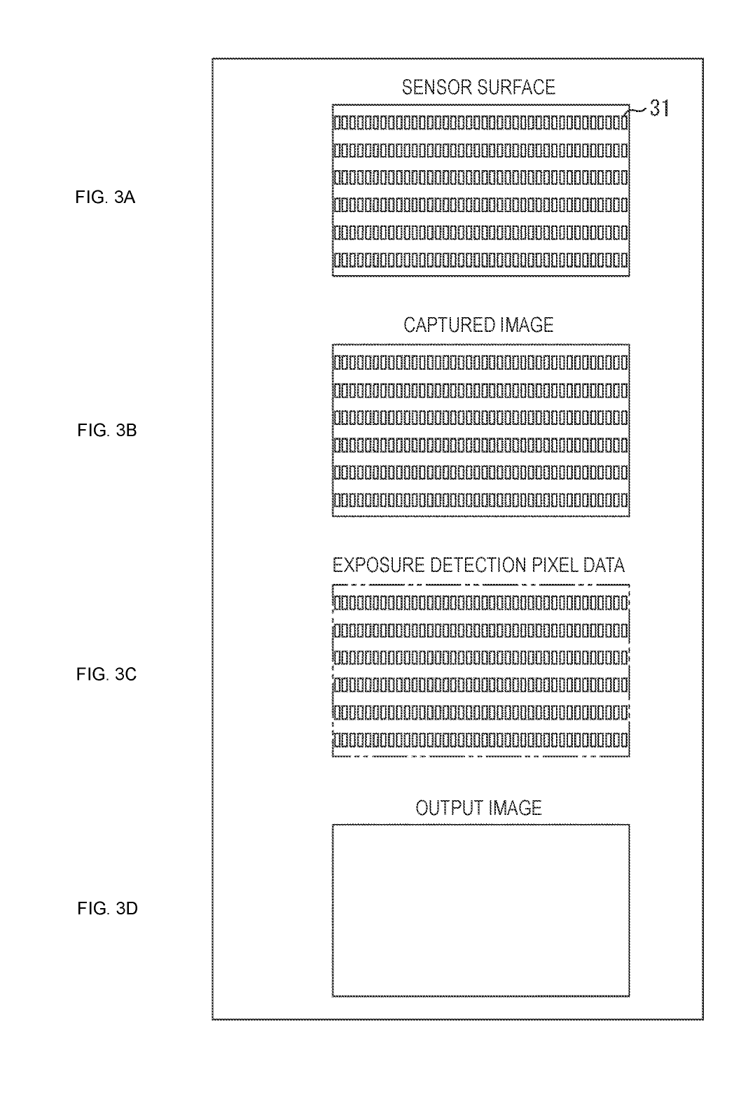

Next, a second arrangement example of OPD pixels arranged in the sensor surface of the image sensor 14 will be described with reference to FIG. 3.

FIG. 3 shows at A the sensor surface of the image sensor 14, and as shown in the drawing, the OPD pixels 31 can be arranged in the form of a plurality of lines in the horizontal direction in the sensor surface.

A captured image captured with the image sensor 14 having a configuration in which the OPD pixels 31 are arranged in the form of lines in this manner will have pixel values of the OPD pixels arranged in the form of lines in accordance with the arrangement of the OPD pixels 31, as shown in FIG. 3 at B. Then, by extracting the pixel values of the OPD pixels from such a captured image, the preprocessing unit 15 acquires exposure detection pixel data as shown in FIG. 3 at C. Detection is performed by the exposure detection signal processing unit 16 using such exposure detection pixel data, and exposure control is performed by the exposure control signal processing unit 17.

On the other hand, the preprocessing unit 15 performs correction processing of interpolating pixel values at locations corresponding to the positions at which the OPD pixels are arranged using remaining pixel values after extracting the exposure detection pixel data from the captured image, that is, using pixel values of effective pixels. Accordingly, the preprocessing unit 15 outputs a corrected image composed of pixel values at all the pixel positions of the image sensor 14, which is subjected to image processing by the output image signal processing unit 18, and an output image as shown in FIG. 3 at D is output.

In this manner, the image sensor 14 in which the OPD pixels 31 are arranged in the form of lines can output a captured image by simple driving control since driving is performed for each line, for example. In addition, as compared with a random arrangement as shown in FIG. 2, it is possible to structurally easily manufacture the arrangement in the form of lines.

Note that the method of arranging the OPD pixels 31 is not limited to a random or line-form arrangement as described above, but various arrangements other than them can be employed.

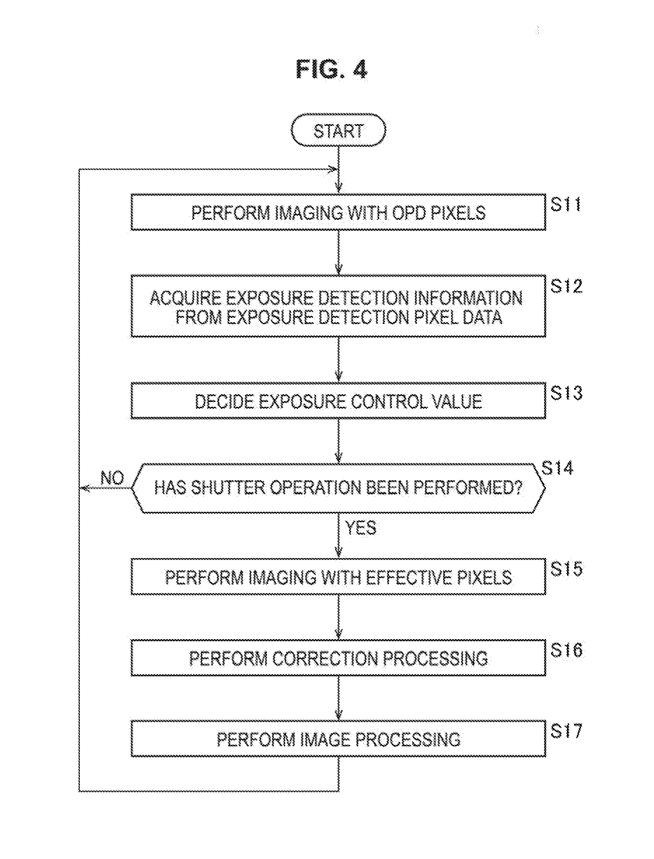

Next, a process of imaging a still image with the imaging device 11 will be described with reference to the flowchart of FIG. 4.

For example, when a user operates an operation unit not shown and sets the imaging mode of the imaging device 11 at a still image, the process is started. In step S11, the operation signal processing unit 20 performs control over the image sensor 14 so as to read out only the pixel values of the OPD pixels 31 in accordance with the user operation, and the image sensor 14 drives only the OPD pixels 31 to perform imaging with the OPD pixels 31. Accordingly, a captured image composed only of the pixel values of the OPD pixels 31 is supplied from the image sensor 14 to the preprocessing unit 15.

In step S12, the preprocessing unit 15 supplies the captured image composed only of the pixel values of the OPD pixels 31 supplied from the image sensor 14 in step S11 to the exposure detection signal processing unit 16 as exposure detection pixel data. The exposure detection signal processing unit 16 acquires exposure detection information from the exposure detection pixel data, and supplies the exposure detection information to the exposure control signal processing unit 17.

In step S13, the exposure control signal processing unit 17 obtains exposure time of the image sensor 14 in which a subject can be captured at optimum brightness on the basis of the exposure detection information supplied from the exposure detection signal processing unit 16 in step S12, and decides an exposure control value for performing control over the image sensor 14. Then, the exposure control signal processing unit 17 performs control of the exposure time over the image sensor 14 in accordance with the exposure control value.

In step S14, the operation signal processing unit 20 determines whether a shutter operation has been performed by a user. For example, when the user performs an operation on a shutter button not shown, and its operation signal is supplied to the operation signal processing unit 20, the operation signal processing unit 20 determines that a shutter operation has been performed by the user.

In a case where the operation signal processing unit 20 determines in step S14 that a shutter operation has not been performed by the user, the process returns to step S11, and a similar process is repeated thereafter. On the other hand, in a case where the operation signal processing unit 20 determines in step S14 that a shutter operation has been performed by the user, the process proceeds into step S15.

In step S15, the operation signal processing unit 20 performs control over the image sensor 14 so as to read out the pixel values of the effective pixels, and the image sensor 14 drives the effective pixels to perform imaging with the effective pixels. At this time, the image sensor 14 performs imaging with the effective pixels for the exposure time in accordance with the exposure control value decided in the immediately preceding step S13.

In step S16, the preprocessing unit 15 performs correction processing of interpolating pixel values at locations corresponding to the positions at which the OPD pixels are arranged using the captured image composed of the pixel values of the effective pixels supplied from the image sensor 14 in step S18, and supplies a corrected image to the output image signal processing unit 18.

In step S17, the output image signal processing unit 18 supplies an output image obtained by carrying out image processing on the corrected image supplied from the preprocessing unit 15 in step S16 to the image output unit 19 for display or recording. After the processing in step S17, the process returns to step S11, and a similar process is repeated thereafter.

As described above, in a case of imaging a still image with the imaging device 11, it is possible to perform driving such that only the pixel values of the OPD pixels 31 of the image sensor 14 are read out in a standby time to wait until a shutter operation is performed by a user, and to achieve reduced power consumption.

That is, in a conventional image sensor, pixel values are read out from all the pixels of the image sensor even in a standby time. In contrast, in the imaging device 11, by reading out only the pixel values of the OPD pixels 31 of the image sensor 14, driving power can be reduced by about 95% in the standby time in a configuration in which the OPD pixels 31 are embedded in a proportion of 5% of all the pixels of the image sensor 14. Furthermore, since the imaging device 11 can stop processing of the output image signal processing unit 18 while driving the exposure detection signal processing unit 16 and the exposure control signal processing unit 17 in the standby time, further reduction in driving power can be expected.

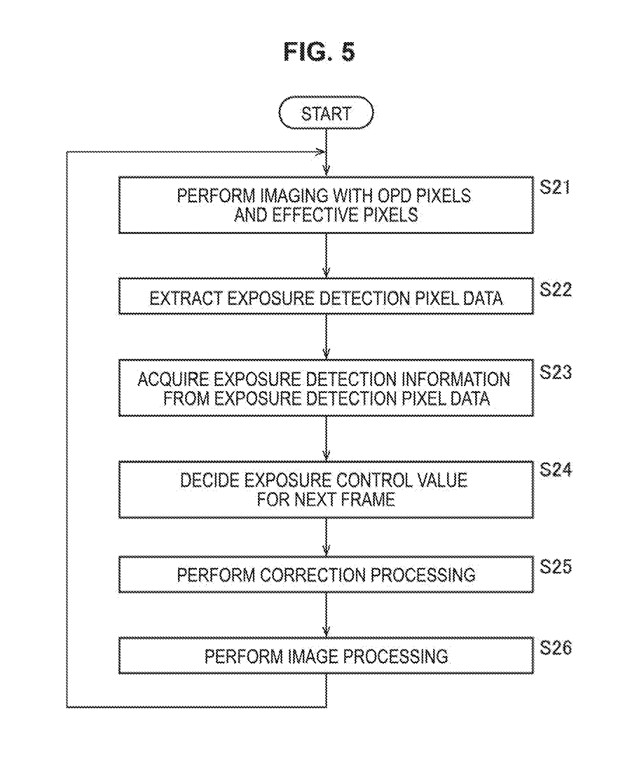

Next, a process of imaging a moving image with the imaging device 11 will be described with reference to the flowchart of FIG. 5.

For example, when a user operates an operation unit not shown and sets the imaging mode of the imaging device 11 at a moving image, the process is started. In step S21, the operation signal processing unit 20 performs control over the image sensor 14 so as to read out pixel values of the OPD pixels 31 and the effective pixels in accordance with the user operation, and the image sensor 14 performs imaging with the OPD pixels 31 and the effective pixels. Accordingly, a captured image composed of the pixel values of the OPD pixels 31 and the effective pixels is supplied from the image sensor 14 to the preprocessing unit 15.

In step S22, the preprocessing unit 15 extracts the pixel values of the OPD pixels 31 from the captured image composed of the pixel values of the OPD pixels 31 and the effective pixels supplied from the image sensor 14 in step S11, and supplies the pixel values to the exposure detection signal processing unit 16 as the exposure detection pixel data.

In step S23, the exposure detection signal processing unit 16 acquires exposure detection information from the exposure detection pixel data supplied from the preprocessing unit 15 in step S22, and supplies the exposure detection information to the exposure control signal processing unit 17.

In step S24, the exposure control signal processing unit 17 obtains an exposure time of the image sensor 14 in which a subject can be captured at optimum brightness on the basis of the exposure detection information supplied from the exposure detection signal processing unit 16 in step S22, and decides an exposure control value for performing control over the image sensor 14. Then, the exposure control signal processing unit 17 performs control of the exposure time over the image sensor 14 in accordance with the exposure control value. Accordingly, when imaging a captured image of a next frame with the image sensor 14, imaging is performed for the exposure time in accordance with the exposure control value decided by the exposure control signal processing unit 17 in the immediately preceding step S24.

In step S25, using a captured image composed of the remaining pixel values (that is, only the pixel values of the effective pixels) after extracting the pixel values of the OPD pixels 31 from a captured image composed of the pixel values of the OPD pixels 31 and the effective pixels, the preprocessing unit 15 performs correction processing of interpolating pixel values at locations corresponding to the positions at which the OPD pixels are arranged, and supplies a corrected image to the output image signal processing unit 18.

In step S26, the output image signal processing unit 18 supplies an output image obtained by carrying out image processing on the corrected image supplied from the preprocessing unit 15 in step S25 to the image output unit 19 for display or recording. After the processing in step S26, the process returns to step S21, and a similar process is repeated thereafter.

As described above, in a case of imaging a moving image with the imaging device 11, the image sensor 14 can perform imaging in accordance with the exposure control value decided on the basis of a captured image of a preceding frame. Therefore, the imaging device 11 can always converge on optimum exposure quickly (in one frame) even in a situation where an exposure environment of a subject abruptly changes, and higher responsiveness can be provided.

### Second Embodiment of Imaging Device

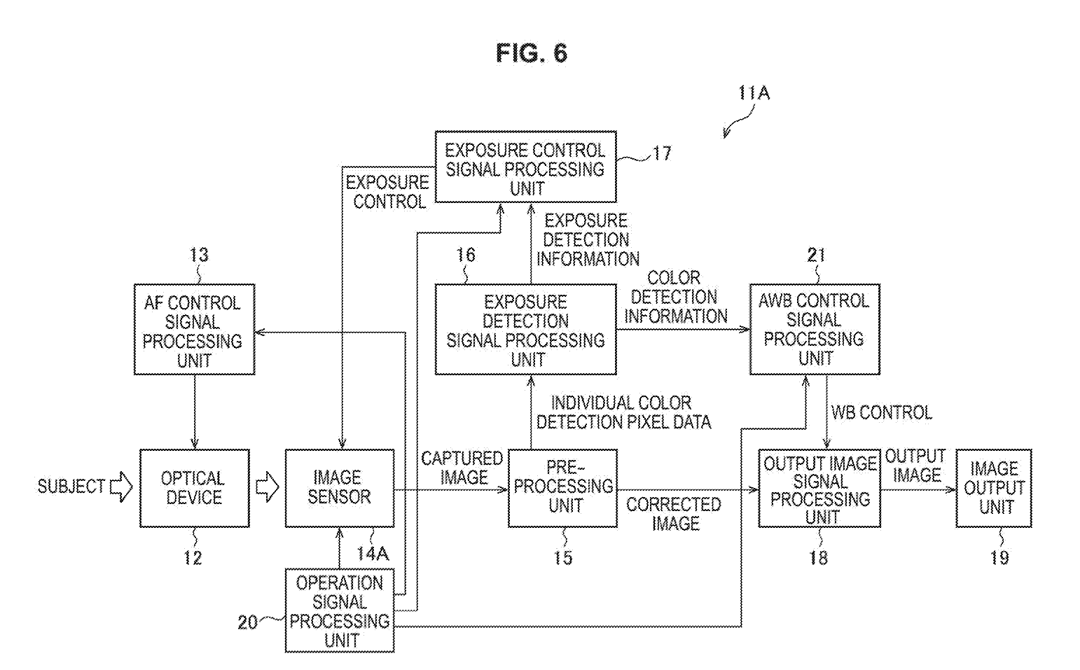

Next, FIG. 6 is a block diagram showing a configuration example of a second embodiment of an imaging device to which the present technology has been applied.

As shown in FIG. 6, an imaging device 11A includes the optical device 12, the AF control signal processing unit 13, an image sensor 14A, the preprocessing unit 15, the exposure detection signal processing unit 16, the exposure control signal processing unit 17, the output image signal processing unit 18, the image output unit 19, the operation signal processing unit 20, and an AWB control signal processing device 21. Here, in the imaging device 11A, blocks configured in common to those of the imaging device 11 of FIG. 1 will be denoted by identical reference characters, and their detailed description will be omitted.

That is, the imaging device 11A has a configuration different from that of the imaging device 11 of FIG. 1 in that the image sensor 14A and the AWB control signal processing device 21 are included.

The image sensor 14A has OPD pixels arranged at random or in the form of lines, similarly to the image sensor 14 of FIG. 1. Then, the OPD pixels of the image sensor 14A can detect brightness having color information, while the OPD pixels of the image sensor 14 of FIG. 1 can detect brightness alone. That is, the image sensor 14A has a color filter laminated on the OPD pixels. The color filter transmits light of predetermined colors (in a red, blue, green, or infrared wavelength range, for example). In addition, the image sensor 14A can output a captured image in which brightness of each color serves as a pixel value of an OPD pixel.

The preprocessing unit 15 extracts the pixel values of the OPD pixels from the captured image supplied from the image sensor 14, and supplies the pixel values to the exposure detection signal processing unit 16 as individual color detection pixel data.

The exposure detection signal processing unit 16 performs detection for each color on the individual color detection pixel data supplied from the preprocessing unit 15, and supplies color detection information to the AWB control signal processing device 21. In addition, the exposure detection signal processing unit 16 supplies exposure detection information obtained by performing detection on the individual color detection pixel data in a proportion in which a balance is achieved among the respective colors (for example, red:blue:green=6:3:1) to the exposure control signal processing unit 17.

The AWB control signal processing device 21 obtains such a white balance that a color tone of a subject is reproduced accurately on the basis of the color detection information supplied from the exposure detection signal processing unit 16, and performs white balance control over the output image signal processing unit 18.

The output image signal processing unit 18 performs image processing of adjusting the white balance for the corrected image supplied from the preprocessing unit 15 in accordance with control of the AWB control signal processing device 21, and supplies an output image to the image output unit 19.

In the imaging device 11A configured in this manner, AWB control can also be achieved at the same time, in addition to performing exposure control on the basis of the pixel values of the OPD pixels. Note that, since the pixel values of the OPD pixels on which the color filter has been laminated have color information in the imaging device 11A, the preprocessing unit 15, when performing correction processing of interpolating pixel values of predetermined OPD pixels with pixel values of neighboring effective pixels, can also use the pixel values of those OPD pixels themselves.

### Third Embodiment of Imaging Device

Next, FIG. 7 is a block diagram showing a configuration example of a third embodiment of an imaging device to which the present technology has been applied.

As shown in FIG. 7, an imaging device 11B includes the optical device 12, the AF control signal processing unit 13, an image sensor 14B, the preprocessing unit 15, the exposure control signal processing unit 17, the output image signal processing unit 18, the image output unit 19, the operation signal processing unit 20, and an exposure phase difference detection signal processing device 22. Here, in the imaging device 11B, blocks configured in common to those of the imaging device 11 of FIG. 1 will be denoted by identical reference characters, and their detailed description will be omitted.

That is, the imaging device 11B has a configuration different from that of the imaging device 11 of FIG. 1 in that the image sensor 14B and the exposure phase difference detection signal processing device 22 are included.

In the image sensor 14B, the OPD pixels have light receiving units divided so as to detect a phase difference in the imaging surface. The light receiving units receive light from a subject. Therefore, pixel values output from the OPD pixels will be in accordance with the amounts of light received by the divided light receiving units, respectively, and a phase difference in the image surface of the image sensor 14B is obtained on the basis of a difference in outputs from those light receiving units.

The pixel values output from such OPD pixels are supplied to the exposure phase difference detection signal processing device 22 as exposure detection pixel data with a phase difference. Then, the exposure phase difference detection signal processing device 22 obtains a phase difference in the image surface of the image sensor 14B on the basis of a difference in the respective pixel values of the light receiving units of the OPD pixels, and supplies phase difference detection information to the AF control signal processing unit 13.

Accordingly, the AF control signal processing unit 13 can perform AF control over the image sensor 14B on the basis of the phase difference detection information.

In the imaging device 11B configured in this manner, AF control can also be achieved at the same time, in addition to performing exposure control on the basis of the pixel values of the OPD pixels.

### Fourth Embodiment of Imaging Device

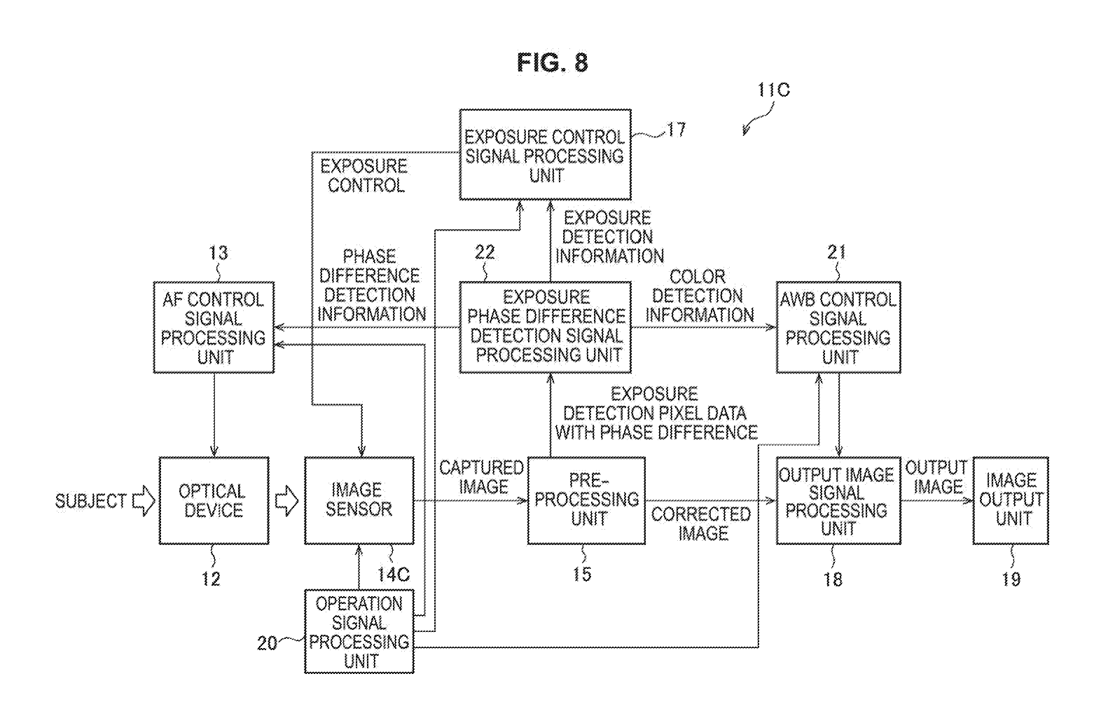

Next, FIG. 8 is a block diagram showing a configuration example of a fourth embodiment of an imaging device to which the present technology has been applied.

As shown in FIG. 8, an imaging device 11C includes the optical device 12, the AF control signal processing unit 13, an image sensor 14C, the preprocessing unit 15, the exposure control signal processing unit 17, the output image signal processing unit 18, the image output unit 19, the operation signal processing unit 20, the AWB control signal processing device 21, and the exposure phase difference detection signal processing device 22. Here, in the imaging device 11C, blocks configured in common to those of the imaging device 11 of FIG. 1 will be denoted by identical reference characters, and their detailed description will be omitted.

That is, the imaging device 11C includes the AWB control signal processing device 21 of FIG. 6 and the exposure phase difference detection signal processing device 22 of FIG. 7. In addition, the image sensor 14C of the imaging device 11C has a red, blur, or green color filter laminated on the OPD pixels similarly to the image sensor 14A of FIG. 6, and is configured to be capable of performing image surface phase difference detection similarly to the image sensor 14B of FIG. 7.

That is, the imaging device 11C includes both the functions of the imaging device 11A of FIG. 6 and the imaging device 11B of FIG. 7, and can achieve all of AE control, AWB control, and AF control as described above at the same time.

Note that when implementing a special exposure mode, such as extended dynamic range imaging, in the imaging device 11 of the present embodiment, each exposure state can be controlled appropriately utilizing the properties that the pixel values of the OPD pixels do not saturate. Accordingly, the imaging device 11 can easily make an adjustment of optimizing visibility and a sense of gradation in extended dynamic range imaging.

In addition, AE control, AWB control, and AF control in the imaging device 11 can be achieved by a control mechanism such as firmware, and control in accordance with the properties of the image sensor 14 can be easily achieved.

### Usage Examples of Image Sensor

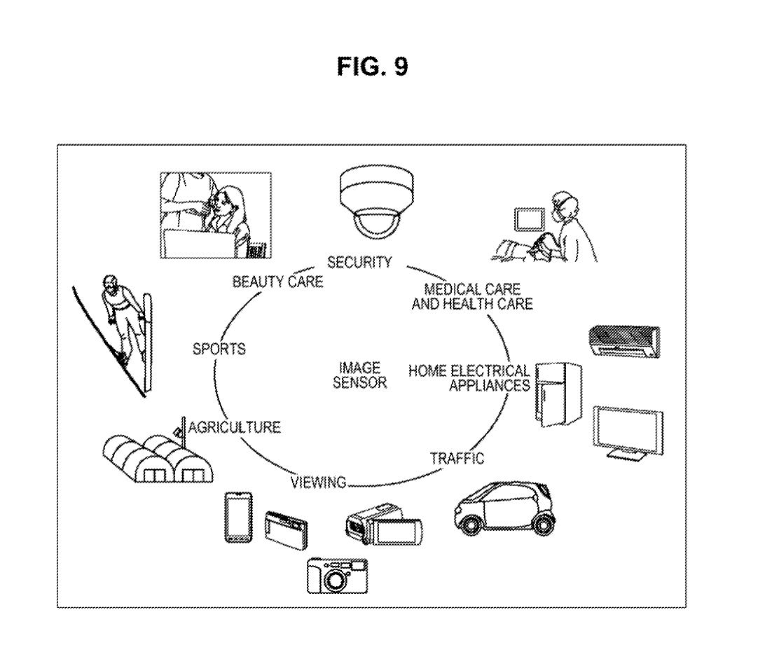

FIG. 9 illustrates the usage examples of the image sensor (the image sensor 14 that the imaging device 11 includes).

The above-described image sensor can be used for, for example, various cases in which light such as visible light, infrared light, ultraviolet light, or X-rays is detected as follows.
Devices that capture images used for viewing, such as a digital camera and a portable appliance with a camera function.
Devices used for traffic, such as an in-vehicle sensor that captures images of the front and the back of a car, surroundings, the inside of the car, and the like, a monitoring camera that monitors travelling vehicles and roads, and a distance sensor that measures distances between vehicles and the like, which are used for safe driving (e.g., automatic stop), recognition of the condition of a driver, and the like.
Devices used for home electrical appliances, such as a TV, a refrigerator, and an air conditioner, to capture images of a gesture of a user and perform appliance operation in accordance with the gesture.
Devices used for medical care and health care, such as an endoscope and a device that performs angiography by reception of infrared light.
Devices used for security, such as a monitoring camera for crime prevention and a camera for personal authentication.
Devices used for beauty care, such as skin measurement equipment that captures images of the skin and a microscope that captures images of the scalp.
Devices used for sports, such as an action camera and a wearable camera for sports and the like.
Devices used for agriculture, such as a camera for monitoring the condition of the field and crops.

Additionally, the present technology may also be configured as below.

(1)

An imaging device including:
an image sensor in which an exposure detection pixel configured to output a pixel value to be used for detection of brightness of a subject and an effective pixel configured to output a pixel value effective for construction of an image are arranged in an imaging effective area to be utilized for imaging of the image; and
an exposure control unit configured to control exposure of the image sensor on the basis of the pixel value output from the exposure detection pixel, in which
the pixel value of the exposure detection pixel has a higher dynamic range than the pixel value of the effective pixel.
   (2)

The imaging device according to (1), further including:
a correction processing unit configured to perform correction processing of obtaining a pixel value for constructing the image at a position where the exposure detection pixel is arranged in the image sensor by interpolation from the pixel value of the effective pixel present in proximity to the exposure detection pixel.
   (3)

The imaging device according to (1) or (2), in which
when in an imaging mode of imaging a still image, the image sensor reads out the pixel value only from the exposure detection pixel in a standby time to wait until a shutter operation of instructing imaging of a still image is performed.
   (4)

The imaging device according to any of (1) to (3), in which
when in an imaging mode of imaging a moving image, the image sensor performs imaging at exposure based on the pixel value of the exposure detection pixel of a preceding frame.
   (5)

The imaging device according to any of (2) to (4), in which
the image sensor has a color filter laminated on the exposure detection pixel, the color filter transmitting light of predetermined wavelength ranges, and
the imaging device further includes
   an individual color detection unit configured to output color detection information obtained by detecting the pixel value of the exposure detection pixel for each of the wavelength ranges, and
   an image processing unit configured to perform image processing of adjusting white balance for an image subjected to the correction processing by the correction processing unit on the basis of the color detection information.
      (6)

The imaging device according to (5), in which
when performing the correction processing, the correction processing unit also uses the pixel value of the exposure detection pixel on which the color filter is laminated.
   (7)

The imaging device according to any of (1) to (6), in which
the exposure detection pixel has light receiving units divided, the light receiving units receiving light from a subject so as to detect a phase difference in an imaging surface of the image sensor in which the exposure detection pixel and the effective pixel are arranged, and
the imaging device further includes
   an image surface phase difference detection unit configured to detect a phase difference in the imaging surface of the image sensor on the basis of a difference in outputs from the divided light receiving units of the exposure detection pixel, and
   a focus control unit configured to perform focus control by driving an optical system that forms an image of the subject on the image sensor in accordance with the phase difference in the imaging surface of the image sensor.
      (8)

An imaging method of an imaging device including an image sensor in which an exposure detection pixel configured to output a pixel value to be used for detection of brightness of a subject and an effective pixel configured to output a pixel value effective for construction of an image are arranged in an imaging effective area to be utilized for imaging of the image, and the pixel value of the exposure detection pixel has a higher dynamic range than the pixel value of the effective pixel,
the imaging method including:
a step of controlling exposure of the image sensor on the basis of the pixel value output from the exposure detection pixel.

Note that the present embodiments are not limited to the embodiments described above, and various changes may be made without departing from the scope of the present disclosure.

### REFERENCE SIGNS LIST

11 imaging device
12 optical device
13 AF control signal processing unit
14 image sensor
15 preprocessing unit
16 exposure detection signal processing unit
17 exposure control signal processing unit
18 output image signal processing unit
19 image output unit
20 operation signal processing unit
21 AWB control signal processing device
22 exposure phase difference detection signal processing device
31 OPD pixels 31

1. An imaging device comprising:
an image sensor in which an exposure detection pixel configured to output a pixel value to be used for detection of brightness of a subject and an effective pixel configured to output a pixel value effective for construction of an image are arranged in an imaging effective area to be utilized for imaging of the image; and
an exposure control unit configured to control exposure of the image sensor on the basis of the pixel value output from the exposure detection pixel, wherein
the pixel value of the exposure detection pixel has a higher dynamic range than the pixel value of the effective pixel.

2. The imaging device according to claim 1, further comprising:
a correction processing unit configured to perform correction processing of obtaining a pixel value for constructing the image at a position where the exposure detection pixel is arranged in the image sensor by interpolation from the pixel value of the effective pixel present in proximity to the exposure detection pixel.

3. The imaging device according to claim 1, wherein
when in an imaging mode of imaging a still image, the image sensor reads out the pixel value only from the exposure detection pixel in a standby time to wait until a shutter operation of instructing imaging of a still image is performed.

4. The imaging device according to claim 1, wherein
when in an imaging mode of imaging a moving image, the image sensor performs imaging at exposure based on the pixel value of the exposure detection pixel of a preceding frame.

5. The imaging device according to claim 2, wherein
the image sensor has a color filter laminated on the exposure detection pixel, the color filter transmitting light of predetermined wavelength ranges, and
the imaging device further includes
an individual color detection unit configured to output color detection information obtained by detecting the pixel value of the exposure detection pixel for each of the wavelength ranges, and
an image processing unit configured to perform image processing of adjusting white balance for an image subjected to the correction processing by the correction processing unit on the basis of the color detection information.

6. The imaging device according to claim 5, wherein
when performing the correction processing, the correction processing unit also uses the pixel value of the exposure detection pixel on which the color filter is laminated.

7. The imaging device according to claim 1, wherein
the exposure detection pixel has light receiving units divided, the light receiving units receiving light from a subject so as to detect a phase difference in an imaging surface of the image sensor in which the exposure detection pixel and the effective pixel are arranged, and
the imaging device further includes
an image surface phase difference detection unit configured to detect a phase difference in the imaging surface of the image sensor on the basis of a difference in outputs from the divided light receiving units of the exposure detection pixel, and
a focus control unit configured to perform focus control by driving an optical system that forms an image of the subject on the image sensor in accordance with the phase difference in the imaging surface of the image sensor.

8. An imaging method of an imaging device including an image sensor in which an exposure detection pixel configured to output a pixel value to be used for detection of brightness of a subject and an effective pixel configured to output a pixel value effective for construction of an image are arranged in an imaging effective area to be utilized for imaging of the image, and the pixel value of the exposure detection pixel has a higher dynamic range than the pixel value of the effective pixel,
the imaging method comprising:
a step of controlling exposure of the image sensor on the basis of the pixel value output from the exposure detection pixel.
